(19) United States
(12) Patent Application Publication
(10) Pub. No.: US 2007/0041542 A1
(43) Pub. Date: Feb. 22, 2007

(54) Connection management in communications systems

(76) Inventors: Steven D. Schramm, San Jose, CA (US); Saurav Chatterjee, San Jose, CA (US); Hemendra Rana, San Jose, CA (US)

Correspondence Address: COURTNEY STANIFORD & GREGORY LLP, P.O. BOX 9686, SAN JOSE, CA, 95157, US

(21) Appl. No.: 11/509,136

(22) Filed: Aug. 23, 2006

Related U.S. Application Data
(63) Continuation-in-part of application No. 10/890,922, filed on Jul. 14, 2004.
(60) Provisional application No. 60/487,143, filed on Jul. 14, 2003.
(60) Provisional application No. 60/710,998, filed on Aug. 23, 2005.
(60) Provisional application No. 60/711,051, filed on Aug. 23, 2005.
(60) Provisional application No. 60/711,053, filed on Aug. 23, 2005.

(51) Int. Cl. H04M 15/06; H04Q 7/20; H04M 1/56

(52) U.S. Cl. 379/142.07; 455/461

(57) ABSTRACT

Connection management in communication systems is described. The connection management includes controlling a connection between client devices and a network using multiple connection modes. One of the available connection modes is selected for use in a connection between the network and a respective client device. Selection of the connection mode is performed according to one or more parameters of the network and the particular client device. A reachable state or presence state of each client device is set 406 in response to data of the respective connection mode.

### RELATED APPLICATIONS

This application is a continuation-in-part (CIP) application of U.S. patent application Ser. No. 10/890,922, filed Jul. 14, 2004, which claims the benefit of U.S. Patent Application No. 60/487,143, filed Jul. 14, 2003.

This application claims the benefit of U.S. patent application No. 60/710,998, filed Aug. 23, 2005.

This application claims the benefit of U.S. patent application No. 60/711,051, filed Aug. 23, 2005.

This application claims the benefit of U.S. patent application No. 60/711,053, filed Aug. 23, 2005.

### TECHNICAL FIELD

The disclosure herein relates generally to communication systems and, in particular, to wireless communication systems.

### BACKGROUND

Mobile communications in today's real-time enterprise can be challenging. The problem is further complicated by changes in the workplace which have led to a more geographically dispersed and highly mobile workforce. In spite of the popularity of electronic mail (email), large numbers of people and employees still depend upon numerous other types of communications to collaborate with colleagues and drive business success. This is especially true for those in sales, service, operations and management roles who rely upon timely access to and coordination with colleagues as well as other employees, customers, partners and suppliers. Thus, communications remain an essential means of conducting business and staying in contact.

As a result of communications being so critical to business today, many professionals and enterprise employees now handle very large numbers of communications each business day. These communications can include disparate types of communications like emails, voicemails, instant messaging to name a few. Managing these large numbers and disparate types of communications consumes large amounts of time during the typical business day. For the growing number of people who spend a significant part of their day away from their offices or in meetings or other events, managing this large number of communications is highly time-consuming, frustrating and inefficient. Consequently, there is a need for communication systems that provide efficient, timely, and proactive real-time management of multiple types of communications.

### INCORPORATION BY REFERENCE

Each publication, patent, and/or patent application mentioned in this specification is herein incorporated by reference in its entirety to the same extent as if each individual publication and/or patent application was specifically and individually indicated to be incorporated by reference.

### BRIEF DESCRIPTION OF THE DRAWINGS

FIG. 1 is a block diagram of an active mobile collaboration (AMC) system, under an embodiment.

FIG. 2 is a block diagram of a communications system that includes an AMC system, under an alternative embodiment.

FIG. 3 is a block diagram of a communications system that includes an AMC system, under another alternative embodiment.

FIG. 4 is a flow diagram of connection management, under an embodiment.

FIG. 5 is a block diagram of an AMC system, under an alternative embodiment.

FIG. 6 is a block diagram of an AMC system, under another alternative embodiment.

FIG. 7 is a block diagram of an AMC system, under yet another alternative embodiment.

FIG. 8 is a block diagram of an AMC system in an enterprise domain, under another alternative embodiment.

FIG. 9 is a block diagram of an AMC system in a public domain coupled across components of an enterprise domain, under another alternative embodiment.

FIG. 10 is a block diagram of an AMC system in an enterprise domain, under still another alternative embodiment.

FIG. 11 is a block diagram of an active mobile collaboration (AMC) system, under an embodiment.

### DETAILED DESCRIPTION

Connection management in communication systems is described herein. The connection management includes controlling a connection between client devices and a network using multiple connection modes. One of the available connection modes is selected for use in a connection between the network and a respective client device. Selection of the connection mode is performed according to one or more parameters of the network and the particular client device. A reachable state or presence state of each client device is set 406 in response to data of the respective connection mode.

In the following description, numerous specific details are introduced to provide a thorough understanding of, and enabling description for, embodiments of the communications systems. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

A communication system is provided herein that uses client-server architectures to improve the efficiency of multiple types of communications. The communication system, referred to herein as the active mobile collaboration (AMC) system, includes a facilitator. The facilitator of an embodiment is an application hosted on one or more servers or other processor-based devices, and communicates a portable or mobile communications device via one or more couplings. The facilitator communicates with the AMC client of a host portable device via a network coupling for example. The facilitator of alternative embodiments can be distributed among one or more portable processor-based devices including the same communication devices as the client application.

The AMC system also includes a client. The client, also referred to as the AMC client, is a component application of a variety of processor-based mobile communication devices and telephones. The components of the AMC system function to improve efficiency of communications by allowing communication device users to increase accessibility of enterprise and personal contact information from mobile phones and other personal digital assistants (PDAs), dynamically manage how and when mobile communications take place, intelligently screen messages, regardless of message type, based on identity of a messaging party, urgency, and subject matter, and determine which contacts in a directory are available to talk and which ones choose not to be disturbed, to name a few.

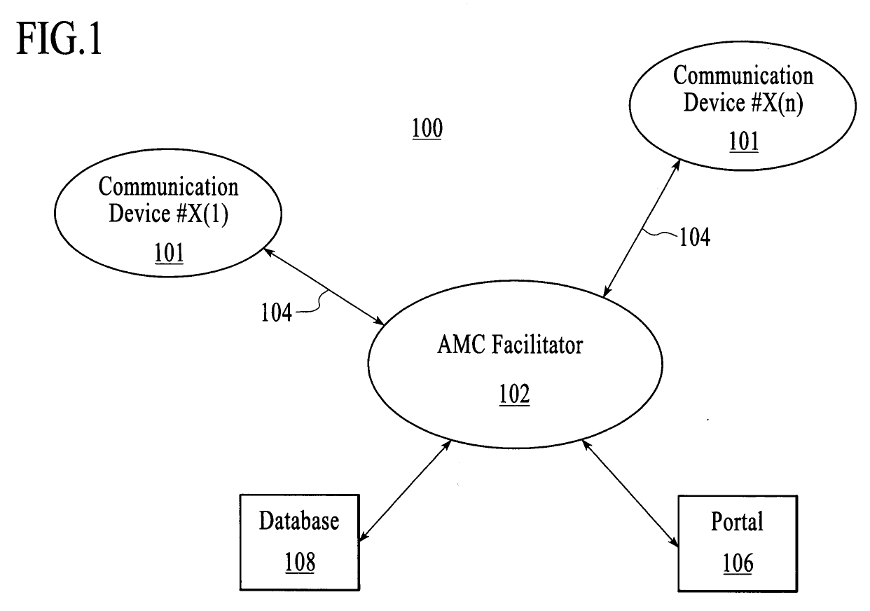

FIG. 1 is a block diagram of an active mobile collaboration (AMC) system 100, under an embodiment. The AMC system 100 includes any number X(n) of communication devices 101 coupled for communication via one or more facilitators 102 and one or more couplings 104. One or more of the communication devices 101 include an AMC client application. Likewise, the facilitator 102, also referred to herein as the AMC server 102, includes a facilitator application. The AMC client and facilitator function to allow users of the communication devices to dynamically manage how and when mobile calls take place, intelligently screen calls based on caller identity, urgency, and subject matter, determine which contacts in a directory are available to talk and which ones choose not to be disturbed, and increase accessibility of enterprise and personal contact information from mobile phones. The AMC system 100 of an embodiment also includes couplings with one or more portals 106 and/or one or more databases 108, but is not so limited.

The communication devices 101 and facilitators 102 described herein are processor-based components running or hosting numerous applications or programs. As such, the communication devices 101 and facilitators 102 can include one or more processors (not shown) coupled among any number/combination of components (not shown) known in the art, for example buses, controllers, memory devices, and data input/output (I/O) devices, in any number of combinations.

The communication devices 101 described herein include processor-based electronic devices, for example, cellular telephones, personal computers, portable computing devices, portable telephones, portable communication devices, subscriber devices or units, PDAs, mobile devices, wireless devices, wireline devices, voice over Internet Protocol (VoIP) devices, private branch exchange (PBX) devices, soft clients, and desktop clients to name a few. The communication devices 101, also referred to as handsets, client devices, mobile devices, mobile communication devices, and portable communication devices, can include all such devices and equivalents, and are not limited to the communication devices described above.

The couplings 104 include wired couplings, wireless couplings, and hybrid wired/wireless couplings, but are not so limited. Furthermore, the couplings 104 can include various networks and/or network components (not shown) of a communication service provider or carrier, but are not so limited. The network and corresponding network components, when present in the couplings 104, can be any of a number of network types known in the art including, but not limited to, local area networks (LANs), metropolitan area networks (MANs), wide area networks (WANs), proprietary networks, backend networks, and the Internet.

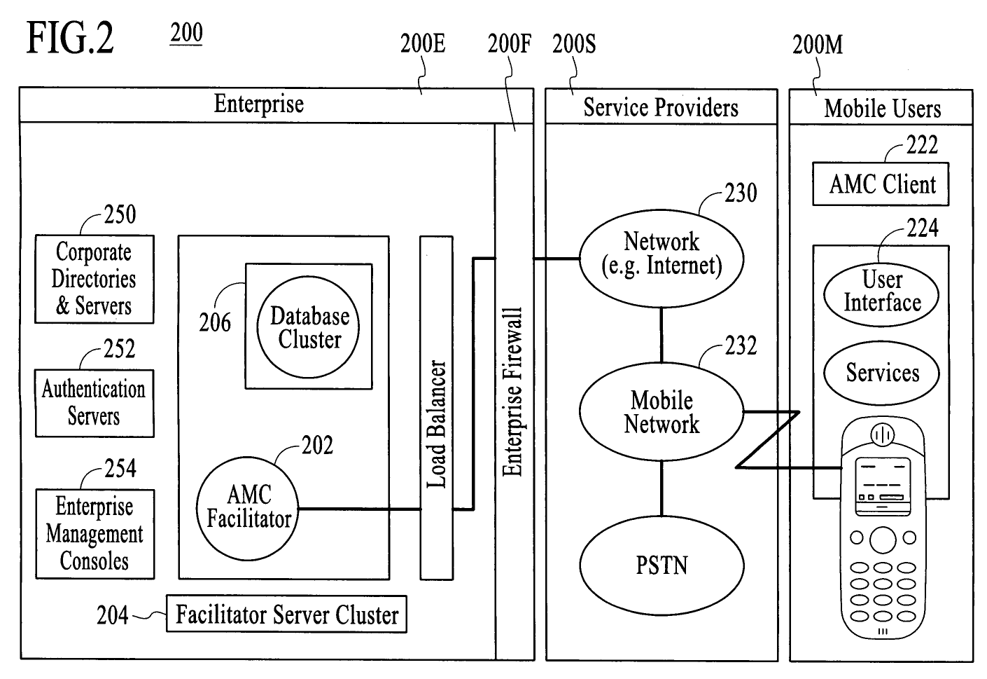

FIG. 2 is a block diagram of a communications system 200 that includes an AMC system, under an alternative embodiment. The AMC system includes a facilitator 202 and a client 222 as described elsewhere herein. The facilitator 202 can be one or more facilitators that form a facilitator server cluster 204 and/or database cluster 206 within the enterprise 200E that are resident behind the enterprise firewall 200F, but the AMC system is not so limited. The host enterprise 200E also includes numerous other components, for example, corporate directories and servers 250, authentication servers 252, and enterprise management consoles 254 to name a few. The facilitator 202 is an integrated component of the host enterprise 200E and as such integrates with one or more components of the enterprise 200E. For example, couplings between the facilitator 202 and messaging and collaboration servers (e.g. Microsoft® Exchange) and/or corporate or other directories of the enterprise 200E allow easy, over-the-air download of personal and corporate contact information to devices, as well as searching of personal and corporate contact directories from the device. Other information of the enterprise 200E can also be delivered to the devices using the AMC system, information including but not limited to calendar information, calendar alerts, calendar reminders, etc.

The facilitator 202 couples to a device of one or more users via one or more network couplings. As an example, the facilitator 202 couples to devices using one or more service provider networks 200S. In this example, the facilitator 202 couples to one or more service provider networks or infrastructures 200S via network couplings 230 (e.g. Internet), and then couples to devices 200M via the respective service provider networks 232. The AMC system protects data transfers between the facilitators 202 and the devices 200M using secure couplings, for example, protected with end-to-end security protocols like Secure Sockets Layer (SSL) or Transport Layer Security TLS cryptographic protocols.

The devices 200M of an embodiment include the AMC client 222. The AMC client 222, also referred to as the client 222, includes a graphical user interface 224 that integrates with the device applications and allows users to receive and scan enterprise information of the enterprise 200E. The enterprise information includes contact information, directory information, alerts that can include calendar reminders, conference notifications and call requests from colleagues, as described herein and in the Related Applications. Call requests include relevant details such as name, urgency, and subject matter to help users move business forward while screening out unwanted interruptions. The client 222 further provides a presence-aware phonebook that lets users find a contact and determine if the contact is available to talk, even before placing a call. The client 222 eliminates the need to manually enter contacts into the host device 200M. Instead, users download personal and/or corporate contact information over-the-air to their devices. The facilitator 202 and client 222 of the AMC system therefore provide automated, two-way synchronization to ensure contacts are backed up and up to date at the enterprise 200E.

An example of the AMC system of an embodiment is available as the Orative Enterprise Software from Orative Corporation of San Jose, Calif. The facilitator is available as the Orative Enterprise Server (e.g. runs on a standards-based, Java 2, Enterprise Edition (J2EE) platform that operates securely behind the enterprise firewall). The client is available as the Orative Client Software (e.g. runs on a variety of popular mobile devices, and leverages the latest application development environments including Symbian OS, Java and BREW to name a few).

While dynamically managing how and when mobile calls take place and intelligently screening calls based on numerous factors described above, the components of the AMC system also improve efficiency of voice communications by increasing accessibility of enterprise and personal contact information from mobile phones. Components of the AMC system of an embodiment support aggregation and management of contact information from various sources including, but not limited to, directories resident on desktop computers, corporate/enterprise directories, and contact information of the mobile device native phonebook, and provide data coupling between those sources and mobile devices hosting the AMC client. This contact information is managed by providing the user with access via the mobile device to dynamically integrated contacts of a contact list and a number of phonebooks from multiple sources. The dynamic integration of multiple disparate directories provided by the AMC system of an embodiment allows a user to indicate the contacts he/she desires among all directories of a corresponding enterprise server, and then dynamically synchronizes all enterprise directories so as to place the desired information from the directories together into a common AMC phonebook, as described in detail below.

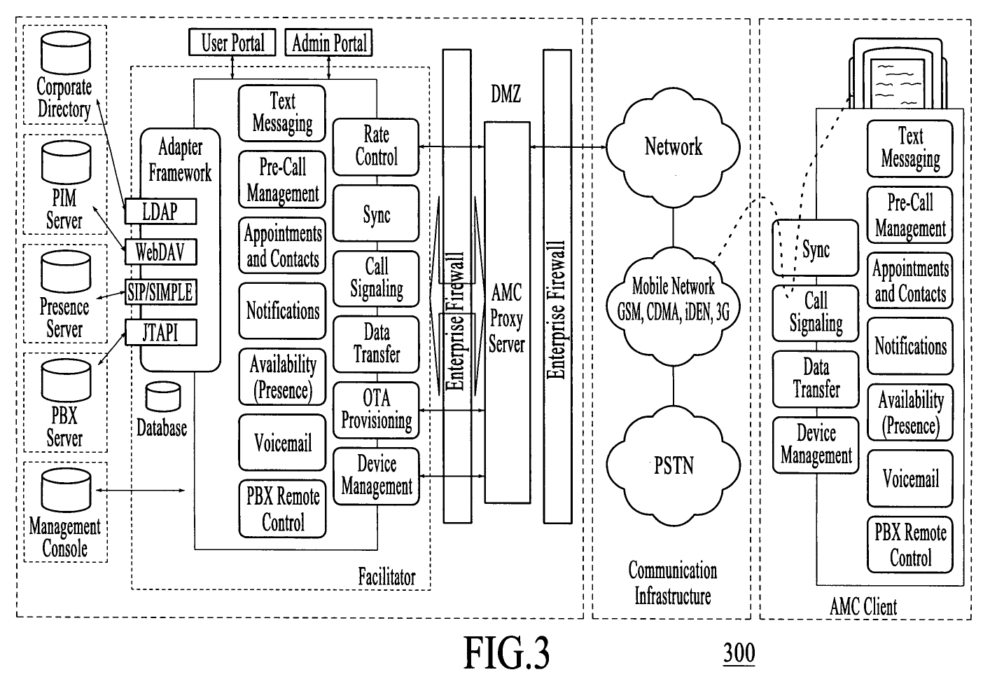

FIG. 3 is a block diagram of a communications system 300 that includes an AMC system, under another alternative embodiment. The communications system 300 includes enterprise components, with which the AMC system is integrated, coupled to client devices via a communication or network infrastructure. The enterprise components include, but are not limited to, one or more of a corporate directory, Personal Information Manager (PIM) server, presence server, Private Branch Exchange (PBX) server, and management console.

The AMC system includes a facilitator as described herein. The facilitator includes an adapter or adapter framework by which the facilitator simultaneously integrates with components of the enterprise and enterprise servers. The facilitator uses an adapter for each directory server to which it integrates. The adapter of an embodiment is a protocol-specific adapter for each directory server to which it integrates; alternatively, the adapter includes vendor-specific adapters. The facilitator integrates with multiple directories simultaneously, including Lightweight Directory Access Protocol (LDAP)/Active Directory, Exchange, Domino, and third-party instant message (IM)/presence server buddy-lists. The AMC adapters convert the data from the enterprise directories (e.g. external) into a common data structure. The converted data is coalesced together into a single directory presented to the user on device via the client. The single directory generated from the data of multiple directories is referred to as the AMC phonebook.

The facilitator includes one or more applications that support multiple functions provided by the AMC system. The AMC system functions include, but are not limited to, test messaging, pre-call management, appointments and contacts, notifications, availability (presence), voicemail, and PBX remote control.

The facilitator couples to a mobile device of one or more users via one or more network couplings or infrastructures. As an example, the facilitator couples to a mobile network using a coupling with another communications network (e.g. Internet). The mobile network or mobile infrastructure, which includes one or more service provider networks associated with respective ones of the mobile devices, provides a coupling to individual mobile devices.

Communications between the facilitator and the mobile device are controlled by the facilitator using one or more components and applications. The functions provided by the facilitator in controlling communications include one or more of rate control, synchronization (sync), call signaling, data transfer, OTA provisioning, and device management to name a few. Optionally, the communications path between the facilitator and the communications network includes an AMC proxy server.

The AMC system manages multiple connection types to optimize connections with devices in response to communication carrier capabilities or characteristics (e.g. communication across disparate networks, connectivity charges, etc.). The AMC connection management thus allows for optimization of the communication paradigm while taking into account characteristics and limitations of communication systems like bandwidth, connection stability and reliability, connectivity pricing plans (some plans charge for staying connected so the user does not want to stay connected any more than necessary), and device limitations (e.g. device power consumption is greater during periods of connection with the host network). In so doing, a connection management component of the AMC system monitors the level of network connectedness or connection state (e.g., reachable, not reachable) for each client device hosted by the network. In contrast to a user's availability, as described below, the contextual data relating to connection state or reachable state is largely out of the user's control. Users are “reachable” if their mobile phone is turned on and they have a consistent and reliable connection to the mobile data network (e.g., GPRS). In contrast, users are “not reachable” if they are disconnected from the mobile data network, engaged in a voice call, or have their client device in the off state. A highly mobile person (e.g., driving) will most likely have an erratic reachable state. The reachable state takes precedence over availability so that, at any given time, subscribers may be reachable or not, regardless of their availability state.

In addition to connection state, components of the AMC system use availability data (e.g. willingness to communicate) to manage the message flow between callers. Therefore, the AMC system of an embodiment facilitates communication between parties through the exchange of contextual data that gives would be callers (call originators) important cues as to the appropriateness of their conversation to the receiver's (call recipient's) current situation, as described herein and in the Related Application. Components of the AMC system monitor the availability state of each user or subscriber (where the user has a handset hosting the AMC client) and broadcast that state to interested parties or “watchers”. In addition the AMC system introduces an Active Call Request that allows a caller to politely ask a receiver if the receiver is ready to take a phone call, and provides discreet response options by which the receiver can provide timely feedback to the caller. Callers have the satisfaction of knowing the receiver acknowledged their call request and will make time to talk.

Contextual availability management empowers users with greater granularity and control over their ability and willingness to communicate from their handset throughout the workday. Users control their availability state from their handsets through selection of an availability profile, where users tailor the availability profiles to suit their personal needs and tastes. Users are encouraged to change their profile whenever their ability to receive and process communications changes, such as entering and leaving a meeting. Availability profiles are controlled manually via direct user action, for example, as well as automatically via predetermined rules selected by the user and/or information of the user's calendar.

The combination of connectedness or connection management (reachable state) and availability determines how the AMC system manages call requests and directs notifications to the user. The AMC system always knows the availability state of each user by virtue of their selected handset profile and the call screening filters they have active. Mobile phones and the programming environments they support do not always know when the mobile data network is reachable. The AMC system typically will not know the reachable state of a user until it tries to contact them over the mobile data network.

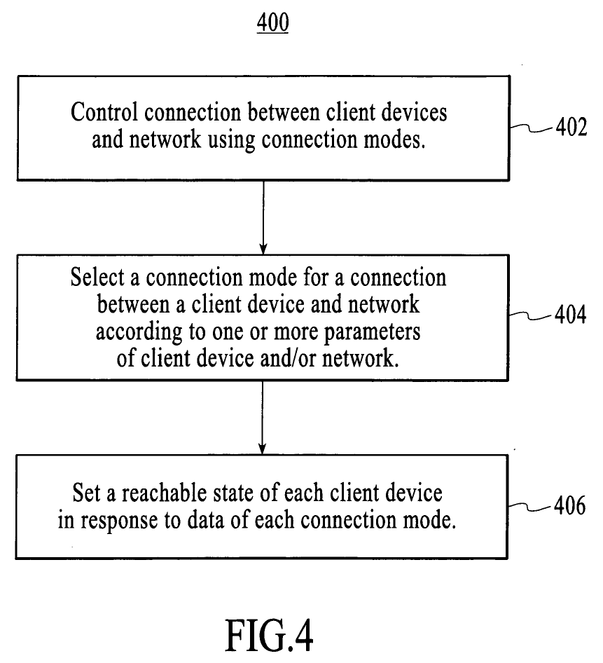

FIG. 4 is a flow diagram of connection management 400, under an embodiment. The connection management includes controlling 402 a connection between client devices and a network using multiple connection modes. One of the available connection modes is selected 404 for use in a connection between the network and a respective client device. Selection 404 of the connection mode is performed according to one or more parameters of the network and the particular client device. A reachable state or presence state of each client device is set 406 in response to data of the respective connection mode.

The connection management component of the AMC system determines the reachable state of a user based on the known connection mode for the AMC client of the client device. The AMC system of an embodiment characterizes reachability according to one of three possible connection modes or states, with each connection state having corresponding methods for inferring the reachable state. The connection modes of an embodiment include but are not limited to SMS wakeup, polling, and persistent connection modes, each of which is described below.

When a client device is operating in the SMS wakeup mode, the facilitator attempts to send an application-directed message (e.g. SMS) to the client device. The AMC client, upon receiving the application-directed message from the facilitator, attempts communication or connection with the facilitator by sending information including the session identification (e.g. sessionId) of the client. The facilitator monitors elapsed time beginning with first transmission of the application-directed message. If the facilitator fails to receive a message or communication from the client device within a pre-specified period of elapsed time (e.g. 30 minutes, one (1) hour, etc.), the facilitator determines the client cannot or will not connect and sets the connection status as “unreachable”. Alternative embodiments of the SMS wakeup connection mode can use any period of elapsed time. The connection status remains as “logged out” until such time as the client device connects with the facilitator.

When a client device is operating in the polling mode the facilitator tracks elapsed time since the client device last connected and synchronized with the facilitator. Once the elapsed time since the last connection exceeds a pre-specified amount of time (e.g. one hour) or a multiple of the polling period (e.g., 1½ times the polling period), the facilitator determines the client cannot or will not connect and sets the connection status as “logged out”. Alternative embodiments of the polling mode can use any period of elapsed time. The connection status remains as “unreachable” until such time as the client device connects with the facilitator.

When a client device is operating in the persistent connection mode the facilitator notes or logs any disconnection event by the client device and tracks elapsed time since the disconnection event. Once the elapsed time since the disconnection event reaches a pre-specified amount of time (e.g. one hour) without the client device attempting to reconnect with the facilitator, the facilitator determines the client cannot or will not connect and sets the connection status as “unreachable”. Alternative embodiments of the persistent connection mode can use any period of elapsed time and are not limited to one hour.

Additionally, when the status is ‘unreachable’, the facilitator changes the availability of the user to indicate the user is unavailable. The connection status remains as “unreachable” until such time as the client device connects with the facilitator, at which time the status is reset to ‘reachable’.

The connection management component therefore uses automatic logout to manage the connection between the facilitator and client device in each of the SMS wakeup, polling, and persistent connection modes as described above.

A user can be logged out of the AMC system of an embodiment. When the user logs out, the facilitator notifies all watchers of the user that this user is not available, ceases calendar-induced profile changes, and ceases polling of the PIM adapters. When the user subsequently logs in to the AMC system, the facilitator notifies all watchers of the user and publishes the availability of the user immediately prior to the most recent log off event, initiates calendar-induced profile changes (if applicable), and initiates polling of the PIM adapter.

The circumstances under which the AMC client and facilitator experience a logout event and communicate with each other using LOGOUT messages include, but are not limited to, forced logout, maintenance logout, melting of the device, and closing of the AMC application. Each of these logout scenarios is described in turn below.

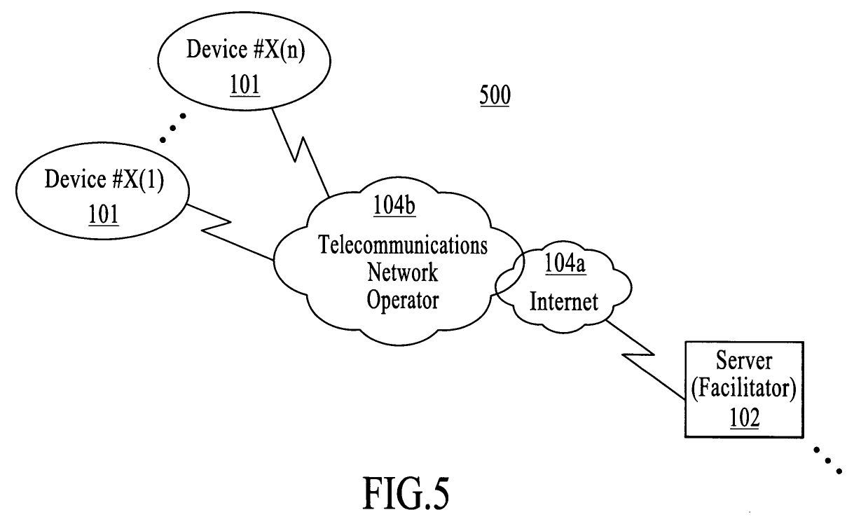

Some examples follow of alternative AMC system configurations that include the facilitator and client described above. FIG. 5 is a block diagram of an AMC system 500, under an alternative embodiment. The AMC system 500 includes a server or other processor-based device hosting the facilitator 102. The facilitator 102 communicates with one or more client devices 101 to provide AMC system functions among the client devices 101 via network couplings that include the Internet 104a and a telecommunications network 104b. The telecommunications network 104b includes, for example, a cellular telephone network or a public switched telephone network (PTSN), but can be other voice and data communication networks as known in the art. The cellular telephone network can use communication protocols that include, for example, Global System for Mobile communication (GSM), General Packet Radio Service (GPRS), Code Division Multiple Access (CDMA), and Time Division Multiple Access (TDMA), but are not so limited.

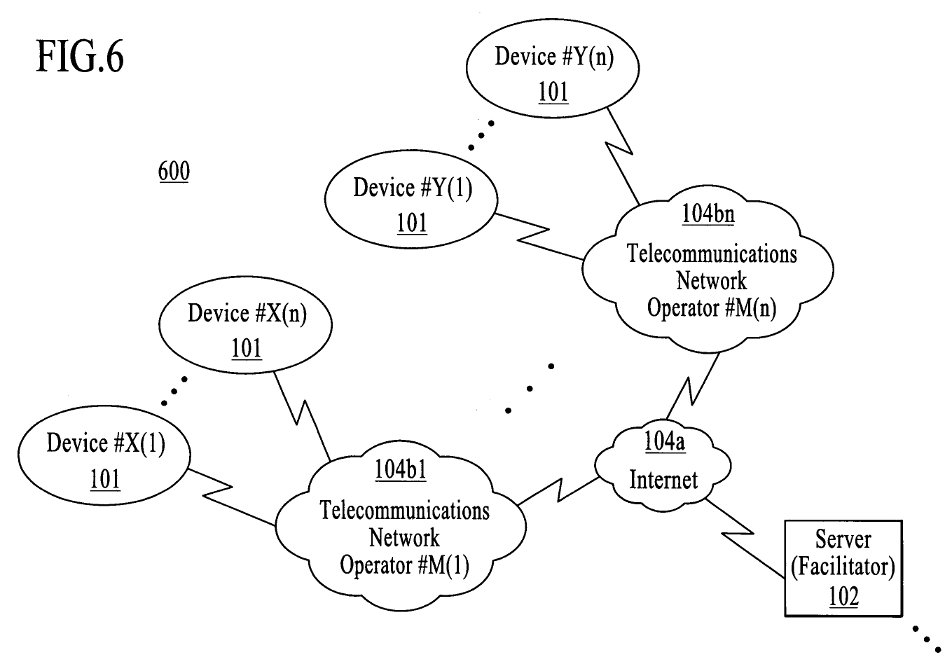

FIG. 6 is a block diagram of an AMC system 600, under another alternative embodiment. The AMC system 600 includes a server hosting the facilitator 102, and the facilitator 102 communicates with one or more client devices 101 to provide AMC system functions among the client devices 101 via network couplings that include the Internet 104a and/or multiple telecommunications networks 104b1 to 104bn. The telecommunications networks 104b1-104bn are as described above with reference to FIG. 5, but are not so limited.

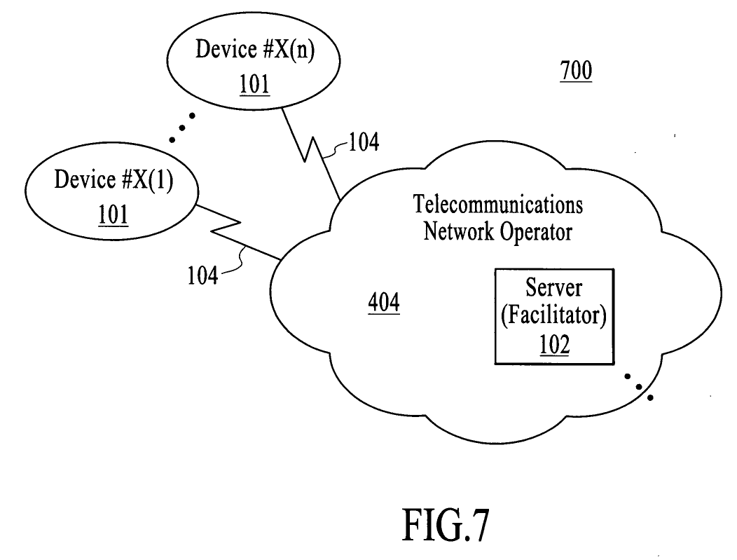

FIG. 7 is a block diagram of an AMC system 700, under yet another alternative embodiment. The AMC system 700 includes a server hosting the facilitator 102, and the server/facilitator 102 is a component of a telecommunications network operator infrastructure. The facilitator 102 communicates with one or more client devices 101 to provide AMC system functions among the client devices 101 via network couplings 104, as described above, but is not so limited.

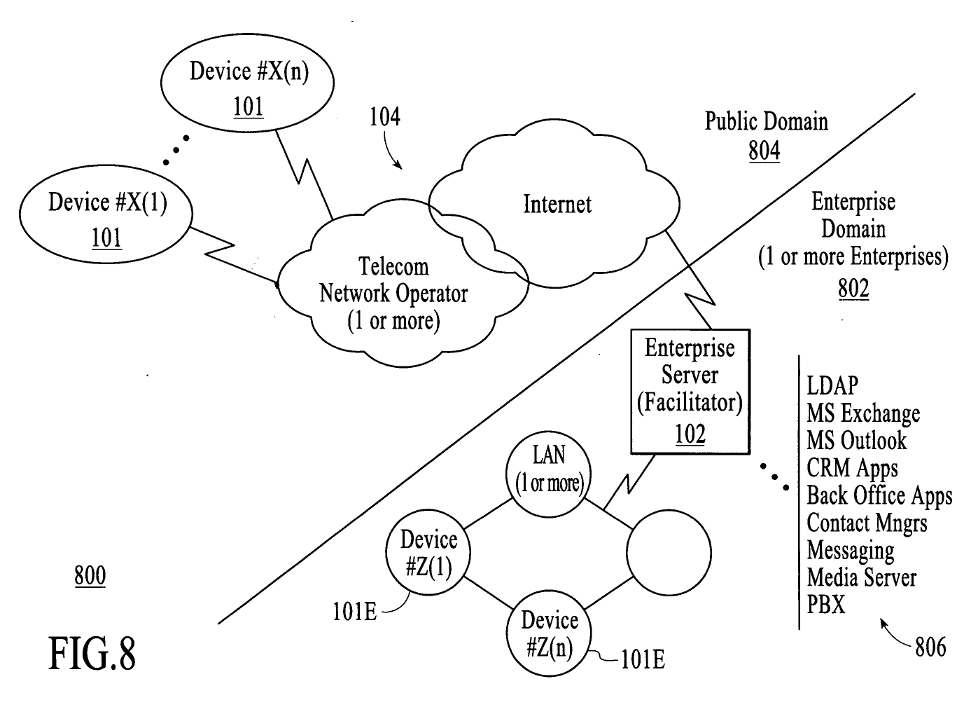

FIG. 8 is a block diagram of an AMC system 800 in an enterprise domain, under another alternative embodiment. The AMC system 800 includes a server hosting the facilitator 102 where the server/facilitator 102 is a component of a corporate or enterprise infrastructure 802. The server can host numerous additional applications 806 in addition to the facilitator 102 or can be dedicated to the facilitator 102. The facilitator 102 communicates with one or more client devices 101 in the public domain 804 to provide AMC system functions among the client devices 101 via network couplings 104. The network couplings 104 include, for example, the Internet and one or more telecommunication service provider infrastructures, but can include any number/type of couplings. The facilitator 102 also communicates with one or more client devices 101E in the enterprise domain 802 to provide AMC system functions among the client devices 101E as described below. The client devices 101E in the enterprise domain 802 are shown coupled to one or more LANs, but are not so limited.

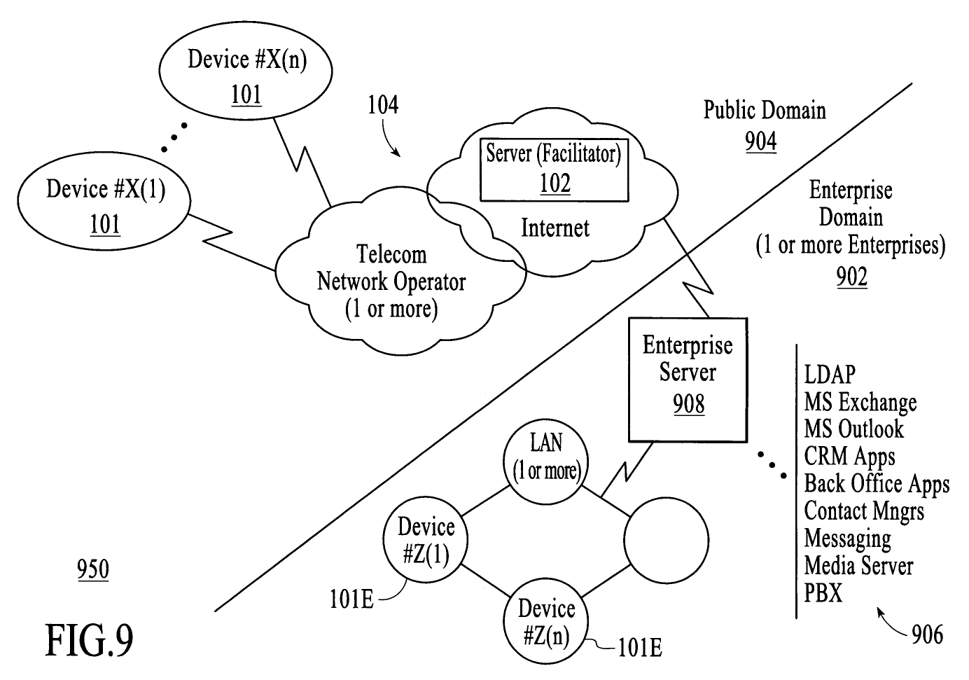

FIG. 9 is a block diagram of an AMC system 950 in a public domain coupled across components of an enterprise domain, under another alternative embodiment. The AMC system 950 includes a server hosting the facilitator 102 where the server/facilitator 102 is a component of a carrier or service provider infrastructure or hosted data center infrastructure for example, but is not so limited. The facilitator 102 communicates with one or more client devices 101 in the public domain 904 to provide AMC system functions among the client devices 101 via network couplings 104. The network couplings 104 include, for example, the Internet and one or more telecommunication service provider infrastructures, but can include any number/type of couplings. The facilitator 102 also communicates with components of the enterprise domain 902 including, for example, one or more client devices 101E, one or more enterprise servers 908, and one or more LANs. The facilitator 102 provides AMC system functions among the client devices 101E as described below. The client devices 101E in the enterprise domain 902 are shown coupled to one or more LANs, but are not so limited.

As an alternative to the couplings of this AMC system 900, the facilitator can be hosted on one or more servers (not shown) of the telecommunications network operator. The facilitator of the telecommunications network operator couples to the enterprise servers via local contact servers (not shown) and/or Virtual Private Network (VPN) couplings, but is not so limited.

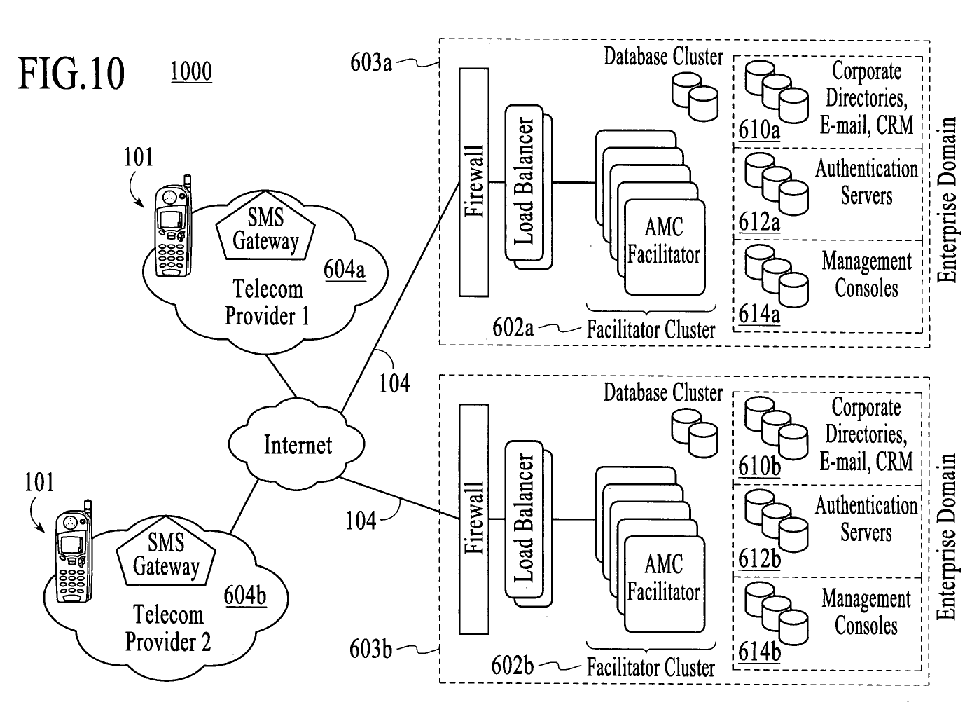

FIG. 10 is a block diagram of an AMC system 1000 in an enterprise domain, under still another alternative embodiment. The AMC system 1000 includes one or more facilitators that form facilitator clusters 602a and 602b within each of a number of enterprise domains 603a and 603b. Facilitators of the facilitator clusters 602a and 602b communicate with one or more client devices 101 to provide AMC system functions among the client devices 101 via network couplings 104. The network couplings 104 include, for example, at least one of the Internet and multiple telecommunication service providers 604a and 604b, but can include any number/type of couplings. The facilitators also couple with at least one of corporate directory servers and/or electronic mail (email) servers 610a/610b, authentication servers 612a/612b, and management consoles 614a/614b of the enterprise domains 603a/603b, but are not so limited.

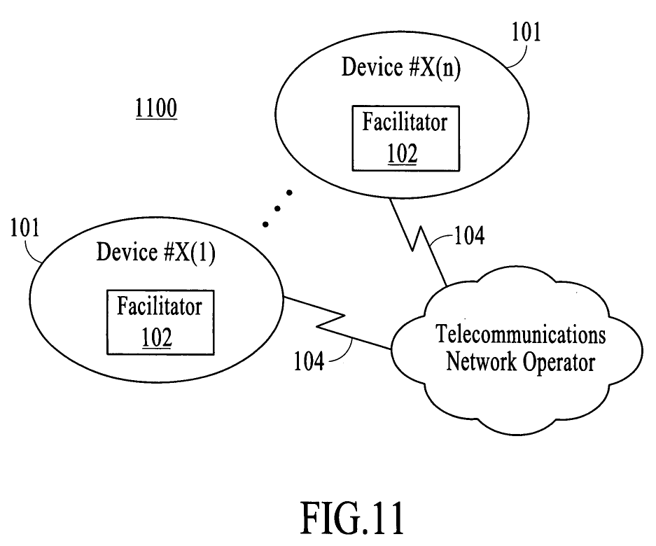

FIG. 11 is a block diagram of an active mobile collaboration (AMC) system 1100, under an embodiment. The AMC system 1100 includes any number X(n) of communication devices 101 coupled for communication via one or more facilitators 102 and one or more couplings 104. One or more of the communication devices 101 include an AMC client application. Additionally, one or more of the communication devices 101 include the facilitator 102. The AMC client applications and facilitator applications function to allow users of the communication devices to dynamically manage how and when mobile calls take place, intelligently screen calls based on caller identity, urgency, and subject matter, determine which contacts in a directory are available to talk and which ones choose not to be disturbed, and increase accessibility of enterprise and personal contact information from mobile phones, as described in detail below.

The AMC system components including the facilitator and AMC client described above function to allow users of the client devices or handsets like cellular telephones to quickly coordinate conversations, screen unwanted calls and interruptions and access enterprise directories. Specifically, the AMC system components increase call success rates by dynamically managing how and when mobile calls take place, let users intelligently screen calls based on caller identity, urgency and subject matter, quickly show which contacts are available to talk and which contacts choose not to be disturbed, reduce interruptions while encouraging urgently needed call-backs, and increase accessibility of enterprise and personal contact information from mobile phones.

The communications systems described herein include a method comprising, monitoring a connection mode of a client device connected to a server, and setting a reachable state of the client device in response to data of the connection mode.

In an embodiment, the method further comprises selecting one of a plurality of connection modes for the connection between the client device and the server, the selecting according to one or more parameters of at least one of the client device and the server.

In an embodiment of a method, the one or more parameters include one or more of server capability, connection bandwidth, connection stability, connection reliability, service provider, server access pricing plans, device model, and device battery life.

In an embodiment, the method further comprises setting one or more of an availability state and a presence state of a user of the client device according to the reachable state.

In an embodiment of a method, monitoring each connection mode includes tracking elapsed time since a communication event of the connection.

In an embodiment of a method, the communication event includes one or more of a connect event, a disconnect event, a logout event, a login event, an authentication event, and a message transfer between the client device and the server.

In an embodiment of a method, setting the reachable state includes setting the reachable state to unreachable when the elapsed time exceeds a time period in the absence of the communication event.

In an embodiment, the method further comprises setting one or more of an availability state and a presence state of a user of the client device according to the reachable state.

In an embodiment of a method, the plurality of connection modes includes a persistent connection.

In an embodiment of a method, the monitoring includes tracking elapsed time since a communication event of the connection.

In an embodiment of a method, setting the reachable state includes setting the reachable state to unreachable when the elapsed time exceeds a time period in the absence of a connection event.

In an embodiment, the method further comprises setting one or more of an availability state and a presence state of a user of the client device to the unavailable state.

In an embodiment of a method, the plurality of connection modes includes a polling mode.

In an embodiment of a method, the monitoring includes tracking elapsed time since a communication event of the connection.

In an embodiment of a method, setting the reachable state includes setting the reachable state to unreachable when the elapsed time exceeds a time period in the absence of a connection event.

In an embodiment of a method, the plurality of connection modes includes a message wakeup mode, wherein the server sends a wakeup message to the client device.

In an embodiment of a method, the monitoring includes, transmitting an electronic message to the client device, and tracking elapsed time since the transmitting.

In an embodiment of a method, setting the reachable state includes setting the reachable state to unreachable when the elapsed time exceeds a time period in the absence of a connection event with the client device.

In an embodiment of a method, the message is a Short Message Service (SMS) message.

The communications systems described herein further include a method comprising, selecting one of a plurality of connection modes for a connection between a client device and the server according to one or more parameters of at least one of the client device and the server, and setting a reachable state of each client device in response to data of each connection mode.

In an embodiment of a method, the one or more parameters include one or more of server capability, connection bandwidth, connection stability, connection reliability, service provider server access pricing plans, device model, and device battery life.

In an embodiment, the method further comprises setting one or more of an availability state and a presence state of a user of the client device according to the reachable state.

In an embodiment, the method further comprises monitoring each connection mode of each client device connected to the server.

In an embodiment of a method, monitoring each connection mode includes tracking elapsed time since a communication event of the connection.

In an embodiment of a method, the communication event includes one or more of a connect event, a disconnect event, and a message transfer between the client device and the server.

In an embodiment of a method, setting the reachable state includes setting the reachable state to unreachable when the elapsed time exceeds a time period in the absence of the communication event.

The communications systems described herein further include a system comprising, a server, wherein the server is coupled to an enterprise and a communication server that includes a plurality of client devices, and a connection management component coupled to the server and configured to use a plurality of connection modes to control a connection between the server and the plurality of client devices, wherein the connection management component is configured to monitor each connection mode of each client device connected to the server, wherein the connection management component is configured to set a reachable state of each client device in response to data of each respective connection mode.

In an embodiment, of a system, the connection management component is configured to select one of a plurality of connection modes for the connection between the client device and the server, the selecting according to one or more parameters of at least one of the client device and the server.

In an embodiment, of a system, the one or more parameters include one or more of server capability, connection bandwidth, connection stability, connection reliability, service provider, server access pricing plans, device model, and device battery life.

In an embodiment, of a system, the connection management component is configured to set one or more of an availability state and a presence state of a user of the client device according to the reachable state.

In an embodiment, of a system, monitoring each connection mode includes tracking elapsed time since a communication event of the connection.

In an embodiment, of a system, the communication event includes one or more of a connect event, a disconnect event, a logout event, a login event, an authentication event, and a message transfer between the client device and the server.

In an embodiment, of a system, setting the reachable state includes setting the reachable state to unreachable when the elapsed time exceeds a time period in the absence of the communication event.

In an embodiment, of a system, the connection management component is configured to set one or more of an availability state and a presence state of a user of the client device according to the reachable state.

In an embodiment, of a system, the plurality of connection modes includes a persistent connection, wherein the monitoring includes tracking elapsed time since a communication event of the connection, wherein setting the reachable state includes setting the reachable state to unreachable when the elapsed time exceeds a time period in the absence of a connection event.

In an embodiment, of a system, the connection management component is configured to set one or more of an availability state and a presence state of a user of the client device to the unavailable state.

In an embodiment, of a system, the plurality of connection modes includes a polling mode, wherein the monitoring includes tracking elapsed time since a communication event of the connection, wherein setting the reachable state includes setting the reachable state to unreachable when the elapsed time exceeds a time period in the absence of a connection event.

In an embodiment, of a system, the plurality of connection modes includes a message wakeup mode, wherein the server sends a wakeup message to the client device.

In an embodiment, of a system, the monitoring includes, transmitting an electronic message to the client device, and tracking elapsed time since the transmitting.

In an embodiment, of a system, setting the reachable state includes setting the reachable state to unreachable when the elapsed time exceeds a time period in the absence of a connection event with the client device.

The communications systems described herein include a computer readable media including executable instructions which, when executed in a processing system, manages connections in communication systems by, monitoring a connection mode of a client device connected to a server, and setting a reachable state of the client device in response to data of the connection mode.

The communications systems described herein include a method comprising, receiving a message addressed to a client device of a user, determining a category of the message, and determining information to be synchronized and when to synchronize between a server and the client device in response to one or more of the category and one or more user actions at the client device.

In one embodiment of a method, the synchronizing includes immediately synchronizing in response to the message when the message is a first category.

In one embodiment of a method, the synchronizing includes synchronizing in response to a user action at the client device when the message is a second category.

In one embodiment of a method, the user action includes one or more of generating a message at the client device and navigating a user interface of the client device.

An embodiment of the method further comprises re-categorizing messages of one or more types of the second category in response to a communication event initiated at the client device.

An embodiment of the method further comprises re-categorizing messages of one or more types of the second category in response to a search of data of the server initiated at the client device.

In one embodiment of a method, the synchronizing includes synchronizing messages of the second category in response to an action including navigating to a first portion of a user interface of the client device, wherein the messages of the second category correspond to presence data of other users.

In one embodiment of a method, the messages of the second category correspond to the other users having a first presence status.

In one embodiment of a method, the first portion is a communications log page of the user interface.

In one embodiment of a method, the first presence status is an active status, wherein the active status indicates the client device has communicated with the other user during a pre-specified period of time.

In one embodiment of a method, the synchronizing includes synchronizing messages of the second category in response to an action including navigating to a second portion of a user interface of the client device, wherein the messages of the second category correspond to presence data of other users.

In one embodiment of a method, the messages of the second category correspond to other users having one or more of a first presence status and a second presence status.

In one embodiment of a method, the second portion is a contacts list of the user interface.

In one embodiment of a method, the first presence status is an active status and the second presence status is a standby status, wherein the active status indicates the user has communicated via the client device with the other user during a pre-specified period of time, wherein the standby status indicates the user has communicated via the client device with the other user outside the pre-specified period of time.

In one embodiment of a method, the synchronizing includes synchronizing messages of the second category in response to a generated message of the first category being generated at the client device, wherein the messages of the second category correspond to another user having one or more of a first presence status and a second presence status.

In one embodiment of a method, the first presence status is an active status and the second presence status is a standby status, wherein the active status indicates the client device has communicated with the other user during a pre-specified period of time, wherein the standby status indicates the client device has communicated with the other user outside the pre-specified period of time.

In one embodiment of a method, a first category is a high-priority message and a second category is lower priority message relative to the first category, wherein the priority is assigned by the server.

In one embodiment of a method, a first category is one or more of a text message, a telephone call notification message, a contact update message to update contact information, and a notification message of an event.

In one embodiment of a method, a second category is a presence message, wherein the presence message includes information of presence and availability of at least one other user.

In one embodiment of a method, the presence message includes one or more of a presence message corresponding to another user whom a user of the client device is actively monitoring and a presence message corresponding to another user whom a user of the client device excludes from active monitoring.

In one embodiment, the method further comprises placing the message in a first queue when the message is a first category and placing the message in a second queue when the message is a second category.

In one embodiment of a method, the synchronizing includes immediately synchronizing contents of the first queue in response to the message when the message is the first category.

In one embodiment of a method, the synchronizing includes synchronizing contents of the second queue in response to a user action at the client device when the message is a second category.

In one embodiment of a method, synchronizing contents of the second queue includes, moving one or more messages of the second queue to the first queue according to a presence status of another user that corresponds to the message, and synchronizing contents of the first queue.

In one embodiment of a method, the user action includes navigating to a first portion of a user interface of the client device, wherein the presence status is an active status that indicates the client device has communicated with the other user during a pre-specified period of time.

In one embodiment of a method, the user action includes navigating to a second portion of a user interface of the client device, wherein the presence status includes one or more of an active status and a standby status, wherein the active status indicates the client device has communicated with the other user during a pre-specified period of time and the standby status indicates the client device has communicated with the other user outside the pre-specified period of time.

In one embodiment of a method, the user action includes generating a message of the first category at the client device, wherein the presence status includes an active status and a standby status, wherein the active status indicates the client device has communicated with the other user during a pre-specified period of time and the standby status indicates the client device has communicated with the other user outside the pre-specified period of time.

In one embodiment of a method, the user actions occur before the receiving.

In one embodiment of a method, the user actions occur after the receiving.

In one embodiment of a method, the category includes a plurality of message types.

The communications systems described herein further include a method comprising, receiving a message addressed to a client device of a user, and automatically synchronizing the message with the client device in response to one or more of a category of the message and a connection type of the client device.

The communications systems described herein further include a method comprising, receiving a message addressed to a client device of a user, and automatically synchronizing the message between a server and the client device in response to at least one parameter of one or more of the message, the client device, the server, and a connection between the client device and the server.

The communications systems described herein further include a system comprising a rate controller coupled to at least one server and at least one communication network, the rate controller configured to determine a category of a message, wherein the message is directed to a client device of a user configured for operation on the network, the rate controller configured to synchronize the message between the server and the client device in response to one or more of the category and one or more user actions at the client device.

In an embodiment of a system, the synchronizing includes immediately synchronizing in response to the message when the message is a first category.

In an embodiment of a system, the synchronizing includes synchronizing in response to a user action at the client device when the message is a second category.

In an embodiment of a system, the user action includes one or more of generating a message at the client device and navigating a user interface of the client device.

In an embodiment of a system, the rate controller is configured to re-categorize messages of one or more types of the second category in response to one or more of a communication event initiated at the client device and a search of data of the server initiated at the client device.

In an embodiment of a system, the synchronizing includes synchronizing messages of the second category in response to an action including navigating to a first portion of a user interface of the client device, wherein the messages of the second category correspond to presence data of other users.

In an embodiment of a system, the synchronizing includes synchronizing messages of the second category in response to an action including navigating to a second portion of a user interface of the client device, wherein the messages of the second category correspond to presence data of other users.

In an embodiment of a system, the synchronizing includes synchronizing messages of the second category in response to a generated message of the first category being generated at the client device, wherein the messages of the second category correspond to another user having one or more of a first presence status and a second presence status.

In an embodiment of a system, the rate controller is configured to place the message in a first queue when the message is a first category and placing the message in a second queue when the message is a second category.

In an embodiment of a system, the synchronizing includes immediately synchronizing contents of the first queue in response to the message when the message is the first category.

In an embodiment of a system, the synchronizing includes synchronizing contents of the second queue in response to a user action at the client device when the message is a second category.

In an embodiment of a system, synchronizing contents of the second queue includes, moving one or more messages of the second queue to the first queue according to a presence status of another user that corresponds to the message, and synchronizing contents of the first queue.

In an embodiment of a system, the user action includes navigating to a first portion of a user interface of the client device, wherein the presence status is an active status that indicates the client device has communicated with the other user during a pre-specified period of time.

In an embodiment of a system, the user action includes navigating to a second portion of a user interface of the client device, wherein the presence status includes one or more of an active status and a standby status, wherein the active status indicates the client device has communicated with the other user during a pre-specified period of time and the standby status indicates the client device has communicated with the other user outside the pre-specified period of time.

In an embodiment of a system, the user action includes generating a message of the first category at the client device, wherein the presence status includes an active status and a standby status, wherein the active status indicates the client device has communicated with the other user during a pre-specified period of time and the standby status indicates the client device has communicated with the other user outside the pre-specified period of time.

The communications systems described herein further include a computer readable media including executable instructions which, when executed in a processing system, provides rate control by, receiving a message addressed to a client device of a user, determining a category of the message, and determining information to be synchronized and when to synchronize between a server and the client device in response to one or more of the category and one or more user actions at the client device.

Aspects of the communications systems described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the communications systems include: microcontrollers with memory (such as electronically erasable programmable read-only memory (EEPROM)), embedded microprocessors, firmware, software, etc. Furthermore, aspects of the communications systems may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that components of the various systems and methods disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described systems and methods may be processed by a processing entity (e.g., one or more processors) within the computer system in conjunction with execution of one or more other computer programs.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the communications systems is not intended to be exhaustive or to limit the systems and methods described to the precise form disclosed. While specific embodiments of, and examples for, the communications systems are described herein for illustrative purposes, various equivalent modifications are possible within the scope of other communications systems and methods, as those skilled in the relevant art will recognize. The teachings of the communications systems provided herein can be applied to other processing systems and methods, not only for the systems and methods described above.

The elements and acts of the various embodiments described above can be combined to provide further embodiments. These and other changes can be made to the communications systems in light of the above detailed description.

In general, in the following claims, the terms used should not be construed to limit the communications systems to the specific embodiments disclosed in the specification and the claims, but should be construed to include all systems that operate under the claims. Accordingly, the communications systems is not limited by the disclosure, but instead the scope of the communications systems is to be determined entirely by the claims.

While certain aspects of the communications systems are presented below in certain claim forms, the inventors contemplate the various aspects of the communications systems in any number of claim forms. Accordingly, the inventors reserve the right to add additional claims after filing the application to pursue such additional claim forms for other aspects of the communications systems.

What is claimed is:

1. A method comprising:
monitoring a connection mode of a client device connected to a server; and
setting a reachable state of the client device in response to data of the connection mode.

2. The method of claim 1, comprising selecting one of a plurality of connection modes for the connection between the client device and the server, the selecting according to one or more parameters of at least one of the client device and the server.

3. The method of claim 2, wherein the one or more parameters include one or more of server capability, connection bandwidth, connection stability, connection reliability, service provider, server access pricing plans, device model, and device battery life.

4. The method of claim 1, comprising setting one or more of an availability state and a presence state of a user of the client device according to the reachable state.

5. The method of claim 1, wherein monitoring each connection mode includes tracking elapsed time since a communication event of the connection.

6. The method of claim 5, wherein the communication event includes one or more of a connect event, a disconnect event, a logout event, a login event, an authentication event, and a message transfer between the client device and the server.

7. The method of claim 5, wherein setting the reachable state includes setting the reachable state to unreachable when the elapsed time exceeds a time period in the absence of the communication event.

8. The method of claim 7, comprising setting one or more of an availability state and a presence state of a user of the client device according to the reachable state.

9. The method of claim 1, wherein the plurality of connection modes includes a persistent connection.

10. The method of claim 9, wherein the monitoring includes tracking elapsed time since a communication event of the connection.

11. The method of claim 10, wherein setting the reachable state includes setting the reachable state to unreachable when the elapsed time exceeds a time period in the absence of a connection event.

12. The method of claim 11, comprising setting one or more of an availability state and a presence state of a user of the client device to the unavailable state.

13. The method of claim 1, wherein the plurality of connection modes includes a polling mode.

14. The method of claim 13, wherein the monitoring includes tracking elapsed time since a communication event of the connection.

15. The method of claim 14, wherein setting the reachable state includes setting the reachable state to unreachable when the elapsed time exceeds a time period in the absence of a connection event.

16. The method of claim 1, wherein the plurality of connection modes includes a message wakeup mode, wherein the server sends a wakeup message to the client device.

17. The method of claim 16, wherein the monitoring includes:
transmitting an electronic message to the client device; and
tracking elapsed time since the transmitting.

18. The method of claim 17, wherein setting the reachable state includes setting the reachable state to unreachable when the elapsed time exceeds a time period in the absence of a connection event with the client device.

19. The method of claim 17, wherein the message is a Short Message Service (SMS) message.

20. A method comprising:
selecting one of a plurality of connection modes for a connection between a client device and the server according to one or more parameters of at least one of the client device and the server; and
setting a reachable state of each client device in response to data of each connection mode.

21. The method of claim 20, wherein the one or more parameters include one or more of server capability, connection bandwidth, connection stability, connection reliability, service provider server access pricing plans, device model, and device battery life.

22. The method of claim 20, comprising setting one or more of an availability state and a presence state of a user of the client device according to the reachable state.

23. The method of claim 20, comprising monitoring each connection mode of each client device connected to the server.

24. The method of claim 23, wherein monitoring each connection mode includes tracking elapsed time since a communication event of the connection.

25. The method of claim 24, wherein the communication event includes one or more of a connect event, a disconnect event, and a message transfer between the client device and the server.

26. The method of claim 24, wherein setting the reachable state includes setting the reachable state to unreachable when the elapsed time exceeds a time period in the absence of the communication event.

27. A system comprising:
a server, wherein the server is coupled to an enterprise and a communication server that includes a plurality of client devices; and
a connection management component coupled to the server and configured to use a plurality of connection modes to control a connection between the server and the plurality of client devices, wherein the connection management component is configured to monitor each connection mode of each client device connected to the server, wherein the connection management component is configured to set a reachable state of each client device in response to data of each respective connection mode.

28. The system of claim 27, wherein the connection management component is configured to select one of a plurality of connection modes for the connection between the client device and the server, the selecting according to one or more parameters of at least one of the client device and the server.

29. The system of claim 28, wherein the one or more parameters include one or more of server capability, connection bandwidth, connection stability, connection reliability, service provider, server access pricing plans, device model, and device battery life.

30. The system of claim 27, wherein the connection management component is configured to set one or more of an availability state and a presence state of a user of the client device according to the reachable state.

31. The system of claim 27, wherein monitoring each connection mode includes tracking elapsed time since a communication event of the connection.

32. The system of claim 31, wherein the communication event includes one or more of a connect event, a disconnect event, a logout event, a login event, an authentication event, and a message transfer between the client device and the server.

33. The system of claim 31, wherein setting the reachable state includes setting the reachable state to unreachable when the elapsed time exceeds a time period in the absence of the communication event.

34. The system of claim 33, wherein the connection management component is configured to set one or more of an availability state and a presence state of a user of the client device according to the reachable state.

35. The system of claim 27, wherein the plurality of connection modes includes a persistent connection, wherein the monitoring includes tracking elapsed time since a communication event of the connection, wherein setting the reachable state includes setting the reachable state to unreachable when the elapsed time exceeds a time period in the absence of a connection event.

36. The system of claim 35, wherein the connection management component is configured to set one or more of an availability state and a presence state of a user of the client device to the unavailable state.

37. The system of claim 27, wherein the plurality of connection modes includes a polling mode, wherein the monitoring includes tracking elapsed time since a communication event of the connection, wherein setting the reachable state includes setting the reachable state to unreachable when the elapsed time exceeds a time period in the absence of a connection event.

38. The system of claim 27, wherein the plurality of connection modes includes a message wakeup mode, wherein the server sends a wakeup message to the client device.

39. The system of claim 38, wherein the monitoring includes:
transmitting an electronic message to the client device; and
tracking elapsed time since the transmitting.

40. The system of claim 39, wherein setting the reachable state includes setting the reachable state to unreachable when the elapsed time exceeds a time period in the absence of a connection event with the client device.

41. A computer readable media including executable instructions which, when executed in a processing system, manages connections in communication systems by:
monitoring a connection mode of a client device connected to a server; and
setting a reachable state of the client device in response to data of the connection mode.
